(19) United States
(12) Patent Application Publication
(10) Pub. No.: US 2026/0145457 A1
(43) Pub. Date: May 28, 2026

(54) PEN AND ADAPTER FOR DETACHABLY ATTACHING PEN TO WRIST STRAP

(71) Applicant: Geumwook LEE, Gyeonggi-do (KR)

(72) Inventor: Geumwook LEE, Gyeonggi-do (KR)

(21) Appl. No.: 19/452,785

(22) Filed: Jan. 19, 2026

Related U.S. Application Data
(63) Continuation of application No. PCT/KR2023/010488, filed on Jul. 20, 2023.

(30) Foreign Application Priority Data
Jul. 17, 2023 (KR) 10-2023-0093056

(51) Int. Cl. B43K 25/00; A45F 5/00

(52) U.S. Cl. CPC B43K 25/00; A45F 5/00; A45F 2005/008

(57) ABSTRACT

A technical problem of the present disclosure is to provide a pen that is easy to carry. To this end, the pen of the present disclosure includes a pen body having a flat rectangular shape, and a cartridge seating portion provided in the pen body, wherein a cartridge is detachably seated in the cartridge seating portion.

### CROSS-REFERENCE TO RELATED APPLICATION

This application is a U.S. Bypass Continuation Application of International Application No. PCT/KR 2023/010488, filed on Jul. 20, 2023, which claims priority to and the benefit of Korean Patent Application No. 10-2023-0093056, filed on Jul. 18, 2023, the disclosure of which is incorporated herein by reference in its entirety.

### BACKGROUND

### Technical Field

The present disclosure relates to a pen.

### Background Art

In general, a pen is a writing instrument for writing characters. Such pens may be classified, depending on a material used for writing on paper, into a ballpoint pen using ink, a pencil using graphite, a brush pen using ink, and the like.

Such a pen includes an elongated pen housing configured to be grasped by a user's hand, and a pen cartridge supported by the pen housing and containing a writing medium (e.g., ink) to be applied to a writing surface. Hereinafter, the pen cartridge may be referred to as a “cartridge.”

However, a conventional pen provides a technical configuration having an elongated shape, and thus has a problem in that portability is difficult. For example, when a user bends the body during outdoor activities while an elongated pen is inserted into or clipped to a pocket, the user may be poked by the pen or the pen may be bent, and thus portability may be difficult. Further, when the user frequently takes the pen out of the pocket due to inconvenience in keeping the pen in the pocket, the pen may not be available in a situation where the pen is needed. Furthermore, since a conventional pen has an elongated shape, a conventional pen has a shape limitation in that a conventional pen is not attachable to a wrist strap such as a watch band or a bracelet.

### SUMMARY

### Technical Problem

A technical problem of the present disclosure is to provide a pen that is easily portable.

Another technical problem of the present disclosure is to provide a pen in which a cartridge is disposed with a maximum length within a limited shape.

Another technical problem of the present disclosure is to provide a pen that is easily graspable by a user's hand.

Another technical problem of the present disclosure is to provide a pen in which a cartridge can be detachably attached with a simple configuration.

Another technical problem of the present disclosure is to provide a pen that allows usage of a cartridge to be checked.

Another technical problem of the present disclosure is to provide an adapter that allows a pen to be maintained in a state of being continuously worn on a user's wrist through a wrist strap such as a watch band or a bracelet.

### Technical Solution

In order to achieve the above-described objects, a pen according to one embodiment of the present disclosure includes: a pen body having a flat rectangular shape; and a cartridge seating portion provided in the pen body and configured such that a cartridge is detachably seated therein. The cartridge seating portion may be disposed to connect two non-adjacent vertices of the pen body, thereby forming a diagonal line of the pen body. The pen body may include through-holes respectively formed through left and right sides with respect to the cartridge seating portion. The cartridge seating portion may have a tubular shape such that the cartridge is insertable. The pen may further include a cartridge removal portion for removing the cartridge from the cartridge seating portion. The cartridge removal portion may be implemented as a cartridge rear-end insertion hole that is formed to penetrate a rear end of the cartridge seating portion so that a rear end of a cartridge already in use is partially exposed, is formed to have a size into which a rear end of an external replacement cartridge is insertable, and guides, when the rear end of the replacement cartridge is inserted, the cartridge in use to be withdrawn through a distal end of the cartridge seating portion. A center of the cartridge rear-end insertion hole may be offset to one side from a center of the cartridge seating portion.

Alternatively, a pen according to one embodiment of the present disclosure includes: a pen body having a rectangular cross-section; and a cartridge seating portion disposed in the pen body and configured to detachably receive a cartridge. The cartridge seating portion may extend diagonally across the rectangular cross-section between two non-adjacent vertices of the pen body. The pen body may include first and second through-holes respectively formed through opposite side surfaces of the pen body with respect to the cartridge seating portion. The cartridge seating portion may define a tubular passage into which the cartridge is insertable. The pen may further include a cartridge removal portion including a cartridge rear-end insertion hole formed through a rear end of the cartridge seating portion. When a first cartridge is seated in the cartridge seating portion, a rear end of the first cartridge may be partially exposed through the cartridge rear-end insertion hole. The cartridge rear-end insertion hole may have a size configured to receive a rear end of a second cartridge. When the rear end of the second cartridge is inserted into the cartridge rear-end insertion hole, the second cartridge may push the first cartridge out through a front end of the cartridge seating portion. A center of the cartridge rear-end insertion hole may be offset from a central axis of the cartridge seating portion.

Each of the through-holes may be rotationally symmetric by 180 degrees about a center of the pen body.

Each of the through-holes may have a triangular shape.

The above-described pen according to one embodiment of the present disclosure may further include a cartridge holding portion holding the cartridge in the cartridge seating portion.

As one example, the cartridge holding portion may include: a small-diameter portion forming a first section of the cartridge seating portion and having an inner diameter smaller than an outer diameter of the cartridge; and an expansion and contraction guide portion provided in the small-diameter portion and configured to expand and contract the small-diameter portion in a radial direction and an opposite radial direction about a center of the small-diameter portion.

A convex portion protruding inward may be formed on an inner surface of a partial section of the small-diameter portion.

The expansion and contraction guide portion may include a plurality of slits formed to penetrate a circumference of the small-diameter portion, formed to extend along a length of the small-diameter portion, and formed with a spacing along the circumference of the small-diameter portion.

The slit may also serve for checking a remaining amount of ink in the cartridge, and a position of a distal end of the slit may be set to allow the remaining amount of ink in the cartridge to be checked.

As another example, the cartridge holding portion may have a structure in which an inner diameter of the cartridge seating portion gradually decreases toward an insertion direction of the cartridge.

Meanwhile, an adapter according to another embodiment of the present disclosure is an adapter for detachably attaching the pen according to the above-described one embodiment of the present disclosure to a wrist strap worn on a user's wrist, and may include: an adapter body; a pen attachment portion forming a portion of the adapter body and configured to detachably attach the pen; and a wrist strap attachment portion forming another portion of the adapter body and configured to be detachably attached to the wrist strap.

The pen attachment portion may include: left and right pen body receiving portions respectively provided at opposite side edges of an upper portion of the adapter body and configured to surround and receive opposite peripheral side surfaces of the pen body; and a pen body fitting portion configured to detachably fit the pen body into the left and right pen body receiving portions.

The pen body fitting portion may include: a pen body support portion connected across respective front ends of the left and right pen body receiving portions and configured to support a front area of the pen body when a rear area of the pen body is pressed from above to below; and a pen body upper locking portion provided at respective rear ends of the left and right pen body receiving portions and configured such that, when the rear area of the pen body is pressed from above to below, the pen body enters and is locked in the pen body upper locking portion.

Each of the left and right pen body receiving portions may be elastically supported by the adapter body.

The pen attachment portion may further include a finger insertion portion forming a space between respective rear ends of the left and right pen body receiving portions and having a recessed shape for inserting a finger to lift a rear end portion of the pen body.

The pen body fitting portion may further include a pen body fitting protrusion formed to protrude from the adapter body so as to correspond to the through-hole of the pen body. Accordingly, when the pen body is fitted below the pen body support portion and the rear area of the pen body is pressed from above to below, the pen body fitting protrusion is fitted into the through-hole.

The pen body fitting protrusion may have a length protruding further above an upper surface of the pen body in a state where the pen body fitting protrusion is fitted into the through-hole, such that, while the rear end portion of the pen body is lifted by inserting one finger into the finger insertion portion, an end of the pen body fitting protrusion can be pressed by another finger.

The wrist strap attachment portion may include: a wrist contact portion provided to be spaced apart from a surface of the adapter body facing a user's wrist; a spacer connection portion connecting the wrist contact portion to one side of the adapter body in a spaced-apart state; and a wrist strap insertion/removal hole forming a space between the adapter body and the wrist contact portion and configured to allow the wrist strap to be inserted and removed.

The wrist strap attachment portion may further include a wrist strap press portion configured to apply a fixing force to the wrist strap in a state where the wrist strap is inserted into the wrist strap insertion/removal hole.

The wrist strap press portion may protrude convexly from the adapter body toward the wrist contact portion and may elastically press and fix the wrist strap inserted into the wrist strap insertion/removal hole.

In the adapter body, a pen body seating area contacted by a lower surface of the pen body may be supported, via a reinforcement rib, at the spacer connection portion of the wrist strap attachment portion.

### Effects of the Invention

As described above, a pen according to embodiments of the present disclosure and an adapter for detachably attaching the pen to a wrist strap may have the following effects.

According to one embodiment of the present disclosure, the pen includes a pen body and a cartridge seating portion, and the pen body provides a technical configuration having a flat rectangular shape. Accordingly, unlike a conventional technique in which a pen body has an elongated straight shape, even when a user bends the body while the pen is inserted into or clipped to a pocket, problems such as the user being poked by the pen or the pen being bent may be prevented. Further, unlike a conventional technique in which a pen body has an elongated straight shape, since the pen body has a flat rectangular shape, the pen body may be manufactured in a size corresponding to a partial section of a watch band, and thus may be attachable to a wrist strap such as a watch band or a bracelet.

In addition, according to one embodiment of the present disclosure, the cartridge seating portion provides a technical configuration in which the cartridge seating portion is disposed to connect two non-adjacent vertices of the pen body, thereby forming a diagonal line of the pen body. Accordingly, the cartridge may be used with a maximum length within a limited length of the rectangular pen body, and, during writing, a user's fingers may be caught on left and right sides with respect to the cartridge seating portion, and thus grasping of the pen body may be facilitated.

In addition, according to one embodiment of the present disclosure, the pen body provides a technical configuration including respective through-holes formed through left and right sides with respect to the cartridge seating portion. Accordingly, during writing, a user's fingers may be more reliably caught in the left and right through-holes with respect to the cartridge seating portion, and thus grasping of the pen body may be further facilitated. Furthermore, as described below, a pen body fitting protrusion of the adapter may be fitted through the through-hole, thereby increasing a fastening force between the pen body and the adapter, and also preventing the pen body from moving rearward of the adapter, thereby preventing the pen body from being separated from the adapter.

In addition, according to one embodiment of the present disclosure, each through-hole provides a technical configuration in which each through-hole is rotationally symmetric by 180 degrees about a center of the pen body. Accordingly, the pen body is attachable to the adapter described below even when the pen body is flipped over, and thus, when attaching the pen body to the adapter, distinguishing between a planar surface and a bottom surface of the pen body is unnecessary, and attachment to the adapter may be performed easily and quickly.

In addition, according to one embodiment of the present disclosure, the cartridge seating portion provides a technical configuration having a tubular shape so that the cartridge is insertable. Accordingly, contact between an outer circumferential surface of the cartridge and the outside may be blocked through the cartridge seating portion, and thus damage such as tearing of the cartridge by an external member may be prevented.

In addition, according to one embodiment of the present disclosure, a technical configuration further including a cartridge holding portion is provided. Accordingly, the cartridge holding portion may hold the cartridge seated in the cartridge seating portion, thereby preventing the cartridge seated in the cartridge seating portion from being easily separated by an external force.

In addition, according to one embodiment of the present disclosure, the cartridge holding portion, as one example, provides a technical configuration including a small-diameter portion and an expansion and contraction guide portion. Accordingly, with a simple configuration, while the cartridge is being inserted into the cartridge seating portion, the cartridge reaches the small-diameter portion, and the small-diameter portion is expanded in a radial direction by the expansion and contraction guide portion, whereby the cartridge may be smoothly inserted. When the insertion is completed, the small-diameter portion is contracted in an opposite direction of the radial direction by the expansion and contraction guide portion, whereby the cartridge may be firmly held.

In addition, according to one embodiment of the present disclosure, a technical configuration is provided in which an inner surface of a partial section of the small-diameter portion has a convex portion protruding inward. Accordingly, when insertion of the cartridge is completed, the convex portion is contracted together with the small-diameter portion in an opposite direction of a radial direction by the expansion and contraction guide portion, whereby the cartridge may be held more firmly.

In addition, according to one embodiment of the present disclosure, the expansion and contraction guide portion provides a technical configuration including slits formed to penetrate a circumference of the small-diameter portion, formed to extend along a length of the small-diameter portion, and formed in plural with an interval along the circumference of the small-diameter portion. Accordingly, without additionally providing a separate elastic member or the like, expansion and contraction of the small-diameter portion may be sufficiently guided by only the plurality of slits while the cartridge is being inserted into the small-diameter portion.

In addition, according to one embodiment of the present disclosure, the slit also serves for checking a remaining amount of ink in the cartridge, and a position of a distal end of the slit is set to allow the remaining amount of ink in the cartridge to be checked. Accordingly, since even a distal end of the cartridge located in a state immediately before ink is fully exhausted is checkable, the remaining amount of ink in the cartridge may be accurately checked by visual observation through the slit until immediately before the ink is fully exhausted.

In addition, according to a modified embodiment of one embodiment of the present disclosure, the cartridge holding portion, as another example, provides a technical configuration having a structure in which an inner diameter of the cartridge seating portion gradually decreases toward an insertion direction of the cartridge. Accordingly, as the cartridge is inserted into the cartridge seating portion, the cartridge is increasingly press-fitted into the cartridge seating portion, and thus, even when the cartridge seating portion is made of a material such as metal that does not expand and contract, the cartridge may be firmly held.

In addition, according to one embodiment of the present disclosure, a technical configuration further including a cartridge removal portion is provided. Accordingly, when a writing medium of the cartridge is exhausted in a state where the cartridge is inserted into the cartridge seating portion and held by the cartridge holding portion, the cartridge may be smoothly withdrawn from the cartridge seating portion through the cartridge removal portion, and thus replacement of the cartridge may be facilitated.

In addition, according to one embodiment of the present disclosure, the cartridge removal portion is implemented as a cartridge rear-end insertion hole, and the cartridge rear-end insertion hole is formed through a rear end of the cartridge seating portion so that a rear end of a cartridge already in use is partially exposed, is formed to have a size into which a rear end of an external replacement cartridge is insertable, and provides a technical configuration configured to guide, when the rear end of the replacement cartridge is inserted, the cartridge in use to be withdrawn through a distal end of the cartridge seating portion. Accordingly, when the rear end of the external replacement cartridge is inserted into the cartridge rear-end insertion hole, the rear end of the cartridge in use is pushed by the inserted replacement cartridge, whereby the cartridge in use may be easily and quickly withdrawn through the distal end of the cartridge seating portion.

In addition, according to another embodiment of the present disclosure, an adapter for detachably attaching the pen according to the above-described one embodiment of the present disclosure to a wrist strap worn on a user's wrist provides a technical configuration including an adapter body, a pen attachment portion, and a wrist strap attachment portion. Accordingly, the pen may be worn on the wrist strap through the wrist strap attachment portion and the pen attachment portion of the adapter, the pen may be removed from the adapter body through the pen attachment portion and used as a writing instrument, and, after use, the pen may be attached to the adapter body again through the pen attachment portion, and ultimately, the pen may be maintained in a state of being continuously worn on the wrist not only in daily life but also in environments such as mountains or the sea.

In addition, according to another embodiment of the present disclosure, the pen attachment portion provides a technical configuration including left and right pen body receiving portions and a pen body fitting portion. Accordingly, the pen body may be smoothly received in the adapter body through the left and right pen body receiving portions, and the pen may be detachably attached to the adapter body easily and quickly in a manner in which the pen body is fitted into the left and right pen body receiving portions through the pen body fitting portion. In particular, since a left-right fitting manner is employed, the pen body is prevented from being separated to left and right sides of the adapter body, thereby increasing assembly stability.

In addition, according to another embodiment of the present disclosure, the pen body fitting portion provides a technical configuration including a pen body support portion and an upper locking portion of the pen body. Accordingly, in a process in which the pen body is inserted between the left and right pen body receiving portions, the pen body may be obliquely fitted below the pen body support portion. In this fitted state, when a rear area of the pen body is pressed from above to below, the pen body support portion supports a front area of the pen body, whereby a pressing force applied to the rear area of the pen body may be fully applied. By the pressing force, the rear area of the pen body is pressed from above to below, whereby the pen body enters and is locked in the upper locking portion of the pen body.

In addition, according to another embodiment of the present disclosure, each of the left and right pen body receiving portions provides a technical configuration elastically supported by the adapter body. Accordingly, while the pen body enters the upper locking portion of the pen body, the left and right pen body receiving portions may be smoothly spread to left and right sides.

In addition, according to another embodiment of the present disclosure, the pen attachment portion provides a technical configuration further including a finger insertion portion. Accordingly, the user may insert the finger into the finger insertion portion to easily lift a rear end portion of the pen body, thereby easily detaching the pen body from the adapter body.

In addition, according to another embodiment of the present disclosure, the pen body fitting portion provides a technical configuration further including a pen body fitting protrusion. Accordingly, when the pen body is fitted below the pen body support portion and a rear area of the pen body is pressed from above to below, the pen body fitting protrusion is fitted into the through-hole of the pen body, thereby increasing a fastening force. Further, after fitting, the pen body is prevented from being separated rearward of the adapter body, thereby further increasing assembly stability.

In addition, according to another embodiment of the present disclosure, the pen body fitting protrusion provides a technical configuration having a length protruding further above an upper surface of the pen body. Accordingly, in a state where the pen body fitting protrusion is fitted into the through-hole, while a user lifts the rear end portion of the pen body by inserting one finger (e.g., an index finger) into the finger insertion portion, another finger (e.g., a thumb) may press an end of the pen body fitting protrusion, and thus the pen body may be easily removed from the adapter body.

In addition, according to another embodiment of the present disclosure, a technical configuration further including a wrist strap attachment portion is provided, and the wrist strap attachment portion includes a wrist contact portion, a spacer connection portion, and a wrist strap insertion/removal hole. Accordingly, the adapter of the present disclosure may be detachably attached to the wrist strap (i.e., mounted on or removed from the wrist strap) easily and quickly in a manner in which the wrist strap is inserted into and removed from the wrist strap insertion/removal hole.

In addition, according to another embodiment of the present disclosure, the wrist strap attachment portion provides a technical configuration further including a wrist strap press portion. Accordingly, in a state where the adapter is attached to the wrist strap, the adapter may be firmly fixed to the wrist strap through the wrist strap press portion.

In addition, according to another embodiment of the present disclosure, a technical configuration is provided in which, in the adapter body, a pen body seating area contacted by a lower surface of the pen body is supported, via a reinforcement rib, at the spacer connection portion of the wrist strap attachment portion. Accordingly, while a rear area of the pen body is pressed from above to below to fit and attach the pen body to the adapter body, a force applied to the pen body seating area is supported by the reinforcement rib, thereby preventing deformation of the adapter body.

### BRIEF DESCRIPTION OF THE DRAWINGS

FIG. 1 is a perspective view schematically illustrating a pen according to one embodiment of the present disclosure.

FIG. 2 is a top view of the pen of FIG. 1.

FIG. 3 is a cross-sectional view taken along line III-III of the pen of FIG. 1.

FIG. 4 is a cross-sectional view taken along line IV-IV of the pen of FIG. 2.

FIG. 5 is a perspective view schematically illustrating an adapter according to another embodiment of the present disclosure.

FIG. 6 is a perspective view of the adapter of FIG. 5 as viewed from a front-upper side.

FIG. 7 is a perspective view of the adapter of FIG. 5 as viewed from a rear-side.

FIG. 8 is a side view of the adapter of FIG. 5.

FIG. 9 is a perspective view schematically illustrating a pen-adapter assembly in which the pen of FIG. 1 is attached to the adapter of FIG. 5.

FIG. 10 is a perspective view of the pen-adapter assembly of FIG. 9 as viewed from a front-upper side.

FIG. 11 is a perspective view of the pen-adapter assembly of FIG. 9 as viewed from a rear side.

FIG. 12 is a top view of the pen-adapter assembly of FIG. 9.

### DETAILED DESCRIPTION

Hereinafter, embodiments of the present disclosure will be described in detail with reference to the accompanying drawings so that those having ordinary skill in the art to which the present disclosure pertains may readily practice the present disclosure. However, the present disclosure may be embodied in various different forms and is not limited to the embodiments described herein.

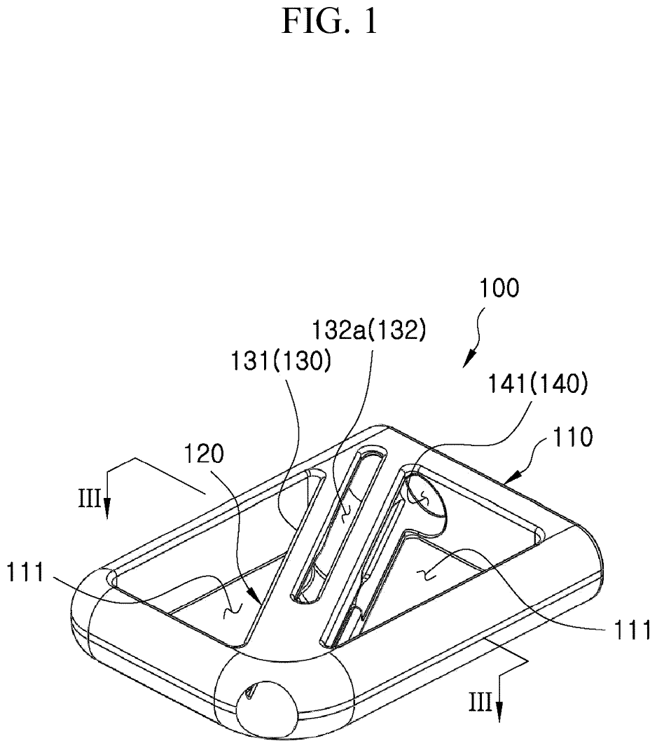

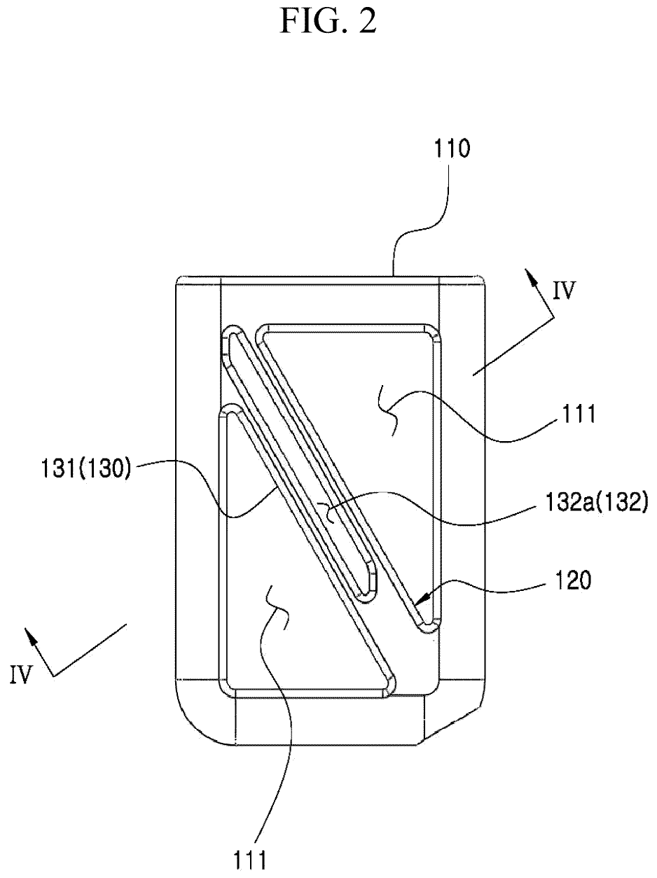

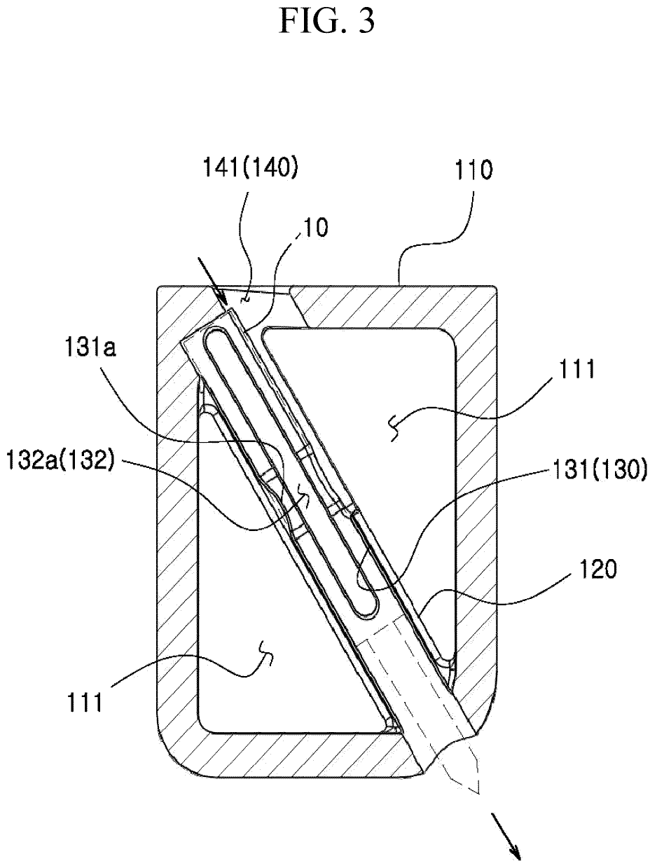

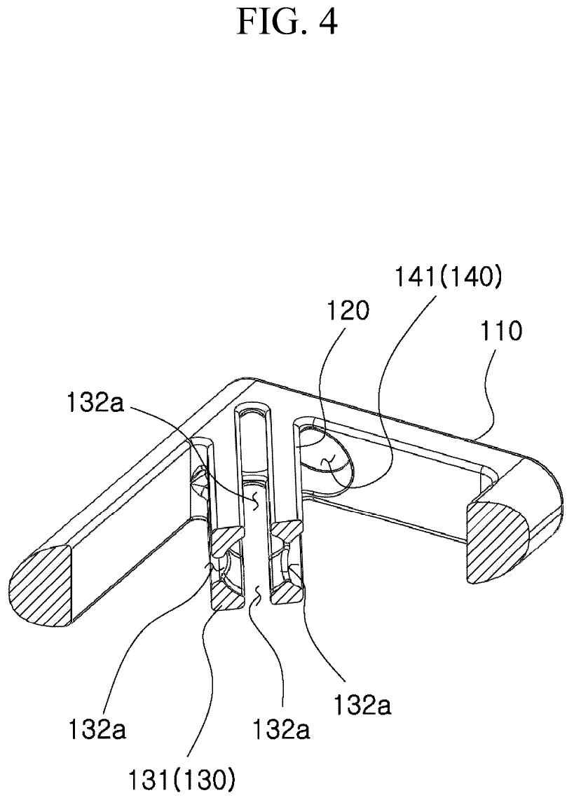

FIG. 1 is a perspective view schematically illustrating a pen according to one embodiment of the present disclosure, FIG. 2 is a top view of the pen of FIG. 1, and FIG. 3 is a cross-sectional view taken along line III-III of the pen of FIG. 1. FIG. 4 is a cross-sectional view taken along line IV-IV of the pen of FIG. 2.

A pen 100 according to one embodiment of the present disclosure includes a pen body 110 and a cartridge seating portion 120, as illustrated in FIGS. 1 to 4. Hereinafter, each component will be described in detail with continued reference to FIGS. 1 to 4.

The pen body 110 is a component forming an exterior and an overall body of the pen 100 according to one embodiment of the present disclosure. The pen body 110 may have a flat rectangular shape having a horizontal length and a vertical length, as illustrated in FIGS. 1 and 2.

The cartridge seating portion 120 is a component for seating a cartridge (see 10 of FIG. 3) including ink or the like. The cartridge seating portion 120 may be provided in the pen body 110 as illustrated in FIGS. 1 to 3, and the cartridge 10 may be detachably seated therein.

Accordingly, since the above-described components are provided, the pen body 110 forms a flat rectangular shape unlike a conventional technique in which a pen body has an elongated straight shape, and thus, even when a user bends the body while the pen 100 is inserted into or clipped to a pocket, problems such as the user being poked by the pen 100 or the pen 100 being bent may be prevented. Further, unlike a conventional technique in which a pen body has an elongated straight shape, since the pen body 110 forms a flat rectangular shape, the pen body 110 may be manufactured in a size corresponding to a partial section of a watch band (not shown), and thus may be attachable to a wrist strap (not shown) such as a watch band or a bracelet.

Hereinafter, the pen body 110 will be described in more detail with reference again to FIGS. 1 and 2.

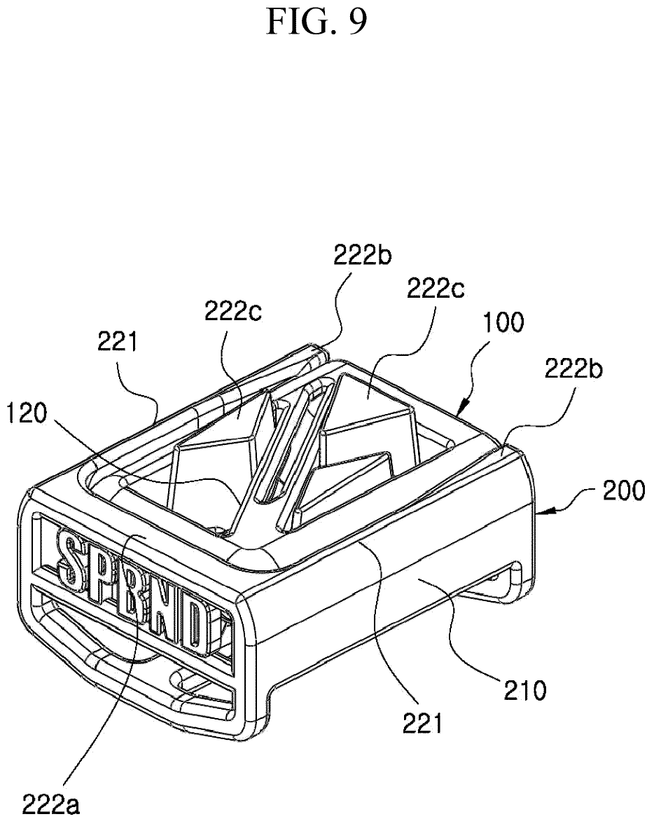

As illustrated in FIGS. 1 and 2, the pen body 110 may include through-holes 111 respectively formed through left and right sides with respect to the cartridge seating portion 120. Accordingly, during writing, a user's fingers may be more reliably caught in the left and right through-holes 111 with respect to the cartridge seating portion 120, and thus grasping of the pen body 110 may be further facilitated. Furthermore, a pen body fitting protrusion 222c of an adapter 200 according to another embodiment of the present disclosure to be described below may be fitted through the through-hole 111 (see FIGS. 9 to 12), thereby increasing a fastening force between the pen body 110 and the adapter 200, and also preventing the pen body 110 from moving rearward of the adapter 200, thereby preventing the pen body 110 from being separated from the adapter 200.

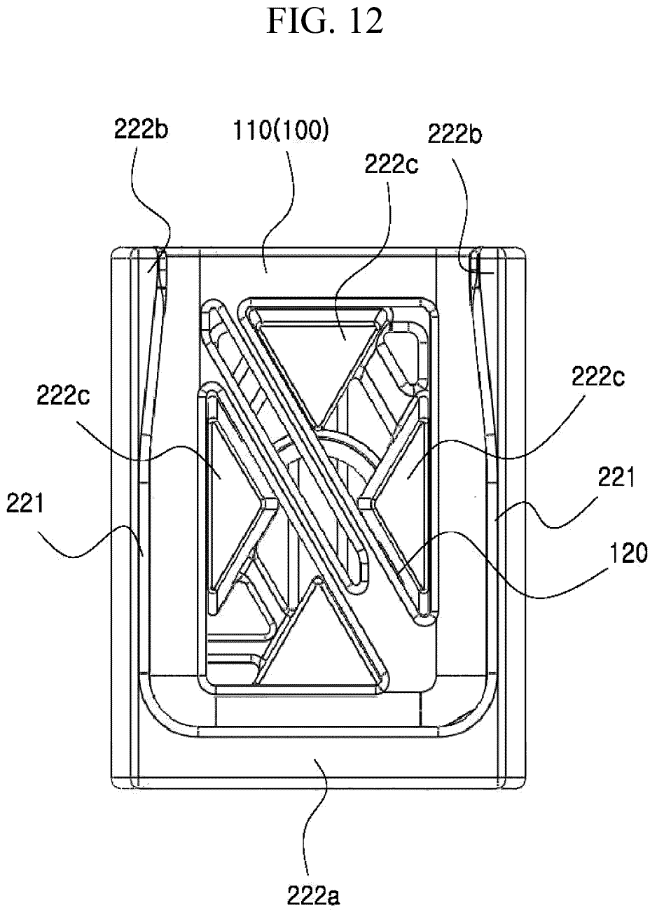

In addition, as illustrated in FIG. 2, each through-hole 111 may be rotationally symmetric by 180 degrees about a center of the pen body 110. Accordingly, the pen body 110 is attachable to the adapter 200 to be described below even when the pen body 110 is flipped upside down (see FIGS. 2 and 12), and thus, when attaching the pen body 110 to the adapter, distinguishing between an upper surface (a planar surface) and a lower surface (a bottom surface) of the pen body 110 is unnecessary, and attachment to the adapter 200 may be performed easily and quickly. Furthermore, as illustrated in FIG. 2, each through-hole 111 may have a triangular shape, and deformation of the rectangular pen body 110 such as bending or being pressed inward may be prevented through such a triangular truss structure.

Hereinafter, the cartridge seating portion 120 will be described in more detail with reference again to FIGS. 1 to 4.

As illustrated in FIGS. 1 and 2, the cartridge seating portion 120 may be disposed to connect two non-adjacent vertices of the pen body 110, thereby forming a diagonal line of the pen body 110. Accordingly, the cartridge seating portion 120 may be disposed with a maximum length within a limited length of the rectangular pen body 110, and thus a cartridge seated therein may also be used with a maximum length. Further, during writing, a user's fingers may be caught on left and right sides with respect to the cartridge seating portion 120, and thus grasping of the pen body 110 may be facilitated.

In addition, as illustrated in FIGS. 1, 3, and 4, the cartridge seating portion 120 may have a tubular shape so that the cartridge 10 is insertable. Accordingly, contact between an outer circumferential surface of the cartridge 10 and the outside may be blocked through the cartridge seating portion 120, and thus damage such as tearing of the cartridge 10 by an external member (not shown) may be prevented.

In addition, a pen 100 according to one embodiment of the present disclosure may further include a cartridge holding portion 130 as illustrated in FIG. 4. The cartridge holding portion 130 may hold a cartridge (10 of FIG. 3) in the cartridge seating portion 120, as illustrated in FIGS. 3 and 4. Accordingly, the cartridge holding portion 130 may prevent the cartridge 10 seated in the cartridge seating portion 120 from being easily separated by an external force.

As one example, as illustrated in FIGS. 1, 3, and 4, the cartridge holding portion 130 may further include a small-diameter portion 131 and an expansion and contraction guide portion 132. The small-diameter portion 131 may form a first section of the cartridge seating portion 120 and may have an inner diameter smaller than an outer diameter of the cartridge 10. The expansion and contraction guide portion 132 may be provided in the small-diameter portion 131 and may guide the small-diameter portion 131 to expand and contract in a radial direction and an opposite radial direction about a center of the small-diameter portion 131. Accordingly, with a simple configuration, while the cartridge 10 is being inserted into the cartridge seating portion 120, the cartridge 10 reaches the small-diameter portion 131 and the small-diameter portion 131 is expanded in the radial direction by the expansion and contraction guide portion 132, whereby the cartridge 10 may be smoothly inserted. When the insertion is completed, the small-diameter portion 131 is contracted in the opposite radial direction by the expansion and contraction guide portion 132, whereby the cartridge 10 may be firmly held.

Furthermore, as illustrated in FIG. 3, a convex portion 131a protruding inward may be further formed on an inner surface of a partial section of the small-diameter portion 131. Accordingly, when insertion of the cartridge 10 is completed, the convex portion 131a is contracted together with the small-diameter portion 131 in an opposite radial direction by the expansion and contraction guide portion 132, whereby the cartridge 10 may be held more firmly.

In addition, as illustrated in FIG. 4, the expansion and contraction guide portion 132 may include a plurality of slits 132a. Here, each slit 132a may be formed to penetrate a circumference of the small-diameter portion 131, may be formed to extend along a length of the small-diameter portion 131, and may be formed with a spacing along the circumference of the small-diameter portion 131. Accordingly, without additionally providing a separate elastic member or the like, expansion and contraction of the small-diameter portion 131 may be sufficiently guided by only the plurality of slits 132a while the cartridge 10 is being inserted into the small-diameter portion 131. In other words, while the cartridge 10 is being inserted into the cartridge seating portion 120, the cartridge 10 reaches the small-diameter portion 131 and the small-diameter portion 131 is expanded in the radial direction by its own elasticity due to the plurality of slits 132a, whereby the cartridge 10 may be smoothly inserted. When the insertion is completed, the small-diameter portion 131 is contracted in the opposite radial direction by its own elasticity due to the plurality of slits 132a, whereby the cartridge 10 may be firmly held.

Furthermore, as illustrated in FIGS. 1 to 3, the slit 132a may also serve for checking a remaining amount of ink in the cartridge 10, and a position of a distal end of the slit 132a may be set to allow the remaining amount of ink in the cartridge 10 to be checked. Accordingly, since even a distal end of the cartridge 10 located in a state immediately before ink is fully exhausted is checkable, the remaining amount of ink in the cartridge 10 may be accurately checked by visual observation through the slit 132a until immediately before the ink is fully exhausted.

As another example, although not illustrated, the cartridge holding portion may have a structure in which an inner diameter of the cartridge seating portion gradually decreases toward an insertion direction of the cartridge. Accordingly, as the cartridge is inserted into the cartridge seating portion, the cartridge may be increasingly press-fitted into the cartridge seating portion, and thus, even when the cartridge seating portion is made of a material such as metal that does not expand and contract, the cartridge may be firmly held.

In addition, a pen 100 according to one embodiment of the present disclosure may further include a cartridge removal portion 140 as illustrated in FIGS. 3 and 4. The cartridge removal portion 140 may allow the cartridge 10 to be removed from the cartridge seating portion 120. Accordingly, when ink of the cartridge 10 is exhausted in a state where the cartridge 10 is inserted into the cartridge seating portion 120 and held by the cartridge holding portion 130, the cartridge 10 may be smoothly withdrawn from the cartridge seating portion 120 through the cartridge removal portion 140, and thus replacement of the cartridge may be facilitated.

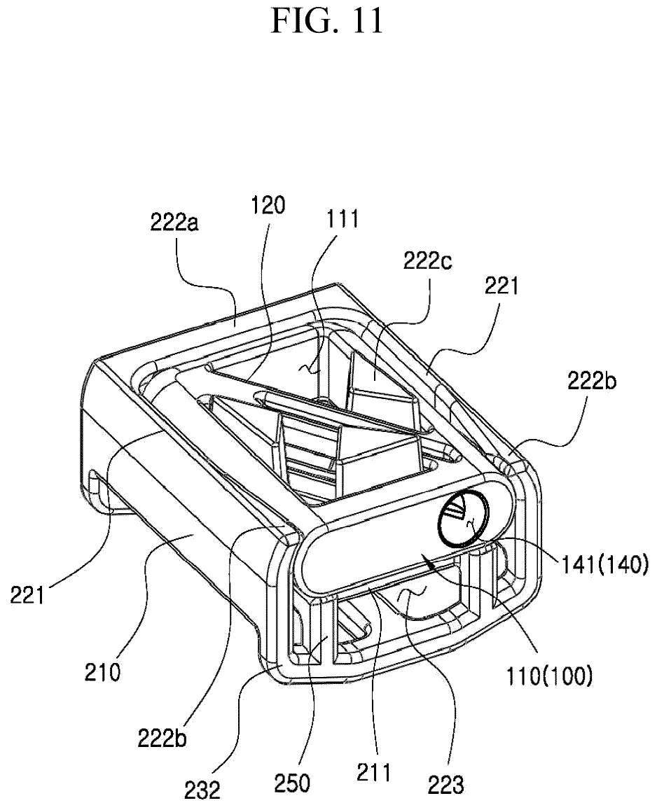

In detail, as illustrated in FIGS. 1, 3, and 4 (see also FIG. 11), the cartridge removal portion 140 may be implemented as a cartridge rear-end insertion hole 141. Here, the cartridge rear-end insertion hole 141 is formed to penetrate a rear end of the cartridge seating portion 120 so that a rear end of a cartridge 10 already in use is partially exposed, is formed to have a size into which a rear end of an external replacement cartridge (not shown) is insertable, and may guide, when the rear end of the replacement cartridge is inserted, the cartridge 10 in use to be withdrawn through a distal end of the cartridge seating portion 120 (see the arrow of FIG. 3). Accordingly, when the rear end of the replacement cartridge (not shown) is inserted into the cartridge rear-end insertion hole 141, the rear end of the cartridge 10 in use is pushed by the inserted replacement cartridge, whereby the cartridge 10 in use may be easily and quickly withdrawn through the distal end of the cartridge seating portion 120.

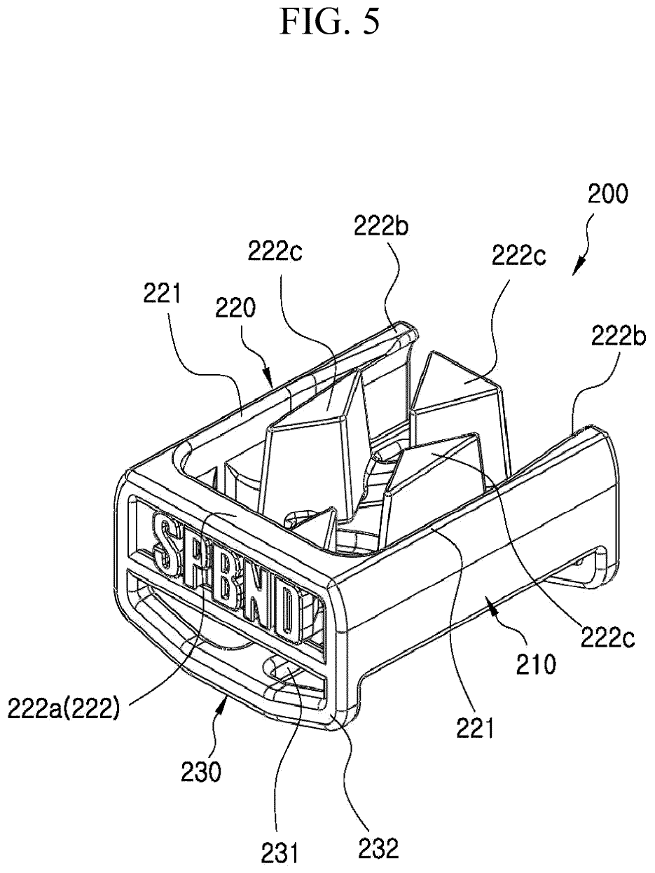

Hereinafter, an adapter 200 according to another embodiment of the present disclosure will be described in detail with reference to FIGS. 5 to 12.

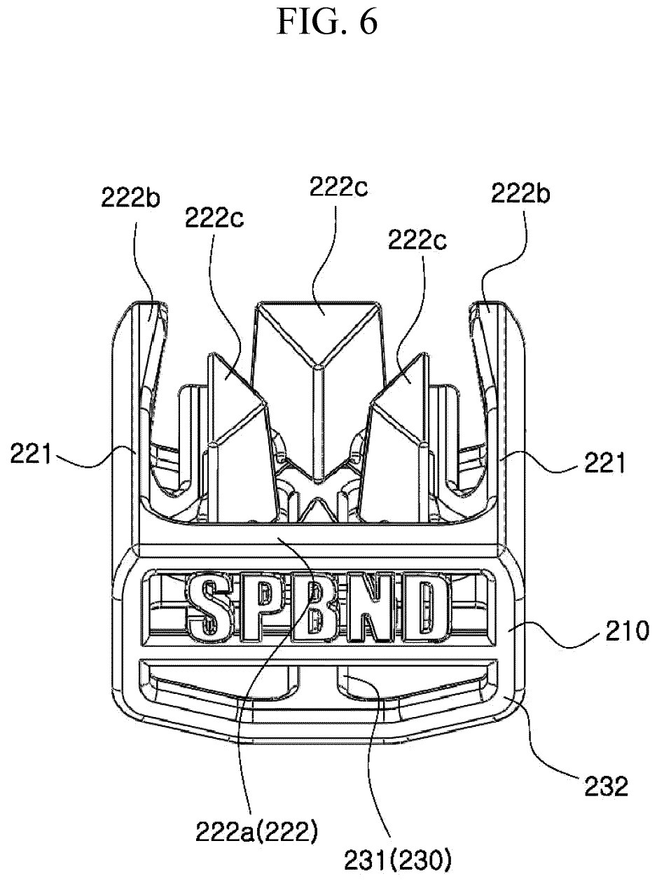

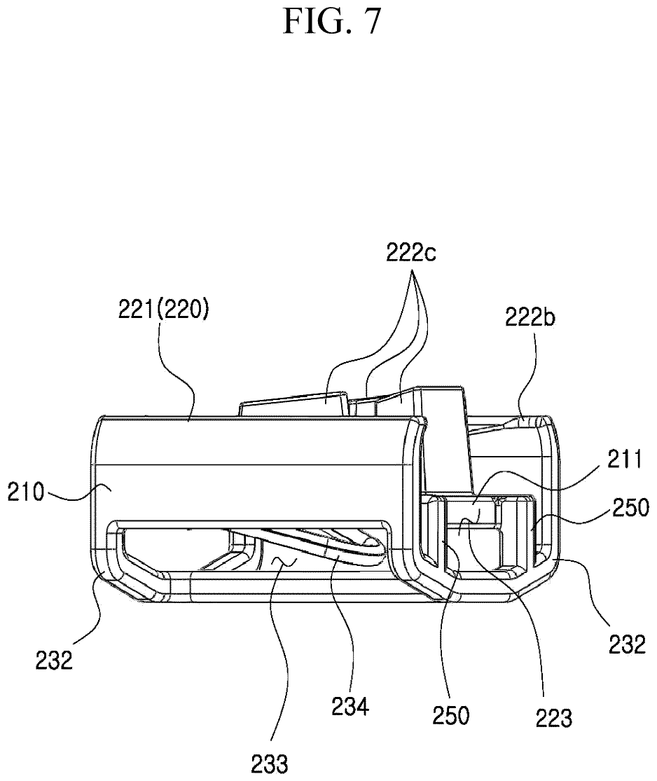

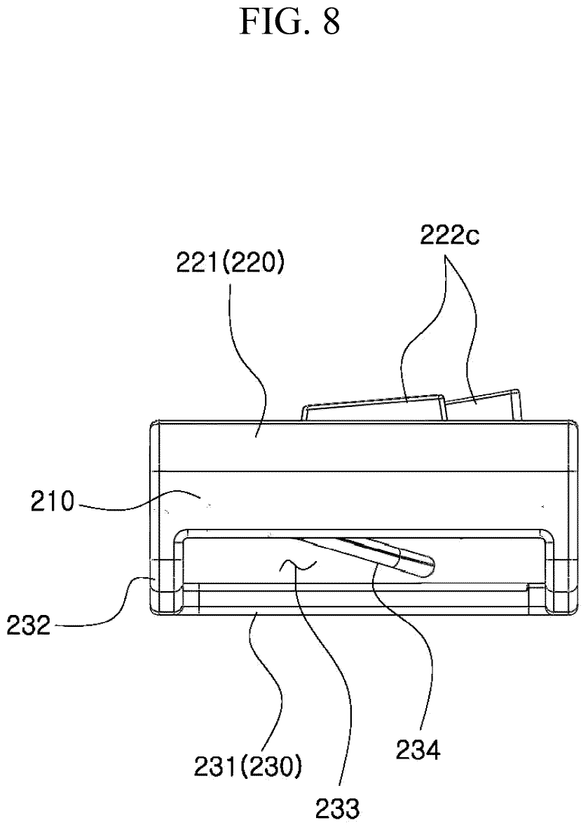

FIG. 5 is a perspective view schematically illustrating an adapter according to another embodiment of the present disclosure, FIG. 6 is a perspective view of the adapter of FIG. 5 as viewed from a front-upper side, and FIG. 7 is a perspective view of the adapter of FIG. 5 as viewed from a rear-side. FIG. 8 is a side view of the adapter of FIG. 5.

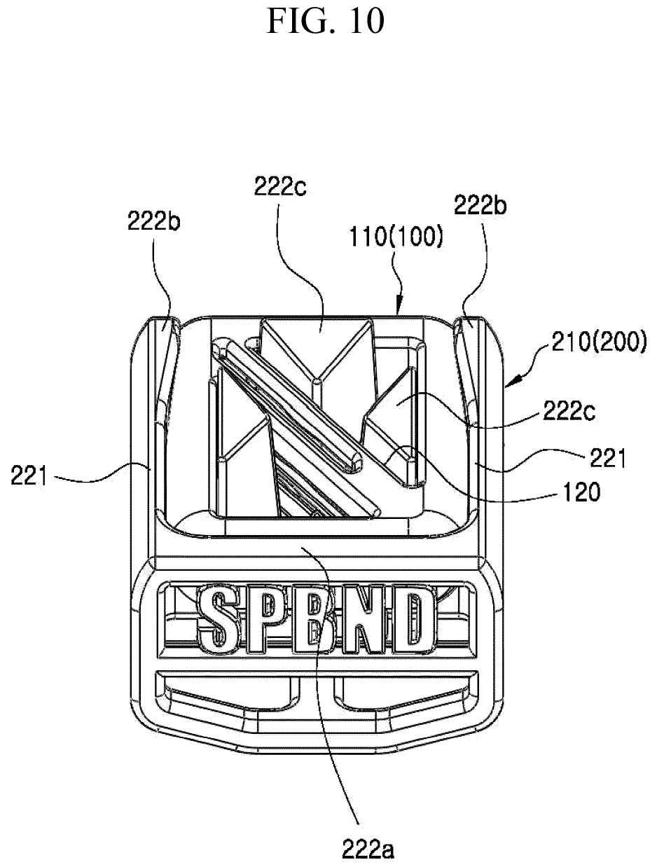

FIG. 9 is a perspective view schematically illustrating a pen-adapter assembly in which the pen of FIG. 1 is attached to the adapter of FIG. 5, FIG. 10 is a perspective view of the pen-adapter assembly of FIG. 9 as viewed from a front-upper side, and FIG. 11 is a perspective view of the pen-adapter assembly of FIG. 9 as viewed from a rear side. FIG. 12 is a top view of the pen-adapter assembly of FIG. 9.

As illustrated in FIGS. 5 to 12, an adapter 200 according to another embodiment of the present disclosure is an adapter for detachably attaching the pen 100 according to the above-described one embodiment of the present disclosure to a wrist strap worn on a user's wrist, and may include an adapter body 210, a pen attachment portion 220, and a wrist strap attachment portion 230. Hereinafter, each component will be described in detail with continued reference to FIGS. 5 to 12.

The adapter body 210 is a component forming a body of the adapter 200 according to another embodiment of the present disclosure. As illustrated in FIGS. 5 to 8, the adapter body 210 may be formed as a single body together with the pen attachment portion 220 and the wrist strap attachment portion 230.

The pen attachment portion 220 is a component configured to detachably attach the pen 100 to the adapter body 210. As illustrated in FIGS. 5, 6, 9, and 10, the pen attachment portion 220 may form an upper portion of the adapter body 210.

The wrist strap attachment portion 230 is a component configured to detachably attach the adapter body 210 to a wrist strap (not shown). As illustrated in FIGS. 7 and 8, the wrist strap attachment portion 230 may form a lower portion of the adapter body 210.

Accordingly, since the above-described components are provided, the pen 100 may be worn on the wrist strap (not shown) through the wrist strap attachment portion 230 and the pen attachment portion 220 of the adapter 200, the pen 100 may be removed from the adapter body 210 through the pen attachment portion 220 and used as a writing instrument, and, after use, the pen 100 may be attached to the adapter body 210 again through the pen attachment portion 220. Ultimately, the pen 100 may be maintained in a state of being continuously worn on the wrist not only in daily life but also in environments such as mountains or the sea.

Hereinafter, the pen attachment portion 220 will be described in more detail with reference again to FIGS. 5 to 12.

As illustrated in FIGS. 5, 6, and 9 to 12, the pen attachment portion 220 may include left and right pen body receiving portions 221 and a pen body fitting portion 222. The left and right pen body receiving portions 221 may be respectively provided at opposite side edges of an upper portion of the adapter body 210 and may receive the pen body 110 in a form surrounding opposite peripheral side surfaces of the pen body 110. The pen body fitting portion 222 may detachably fit the pen body 110 into the left and right pen body receiving portions 221. Accordingly, the pen body 110 may be smoothly received in the adapter body 210 through the left and right pen body receiving portions 221, and the pen body 110 may be detachably attached to the adapter body 210 easily and quickly in a manner in which the pen body 110 is fitted into the left and right pen body receiving portions 221 through the pen body fitting portion 222. In particular, since a left-right fitting manner is employed, the pen body 110 is prevented from being separated to left and right sides of the adapter body 210, thereby increasing assembly stability.

Furthermore, as illustrated in FIGS. 5, 6, 9, and 10, the pen body fitting portion 222 may include a pen body support portion 222a and a pen body upper locking portion 222b. The pen body support portion 222a may be connected across respective front ends of the left and right pen body receiving portions 221, and may support a front area of the pen body 110 when the pen body 110 is fitted below the pen body support portion 222a and a rear area of the pen body 110 is pressed from above to below. The pen body upper locking portion 222b may be provided at respective rear ends of the left and right pen body receiving portions 221, and, when a rear area of the pen body 110 is pressed from above to below, the pen body 110 may enter and be locked in the pen body upper locking portion 222b. Accordingly, in a process in which the pen body 110 is inserted between the left and right pen body receiving portions 221, the pen body 110 may be obliquely fitted below the pen body support portion 222a, and, in this fitted state, when a rear area of the pen body 110 is pressed from above to below, the pen body support portion 222a supports a front area of the pen body 110 such that a pressing force applied to the rear area of the pen body 110 may be fully applied. By the pressing force, the rear area of the pen body 110 is pressed from above to below, whereby the pen body 110 enters and is locked in the pen body upper locking portion 222b.

In addition, each of the left and right pen body receiving portions 221 may be elastically supported by the adapter body 210. Accordingly, while the pen body 110 enters the pen body upper locking portion 222b, the left and right pen body receiving portions 221 may be smoothly spread to left and right sides.

In addition, as illustrated in FIGS. 7 and 11, in the adapter body 210, a pen body seating area 211 contacted by a lower surface of the pen body 110 may be supported, via a reinforcement rib 250, at a spacer connection portion 232 of a wrist strap attachment portion 230 to be described below. Accordingly, while a rear area of the pen body 110 is pressed from above to below to fit and attach the pen body 110 to the adapter body 210, a force applied to the pen body seating area 211 is supported by the reinforcement rib 250, thereby preventing deformation of the adapter body 210.

In addition, as illustrated in FIGS. 7 and 11, the pen attachment portion 220 may further include a finger insertion portion 223. The finger insertion portion 223 may form a space between respective rear ends of the left and right pen body receiving portions 221, and may have a recessed shape for inserting a finger to lift a rear end portion of the pen body 110. Accordingly, the user may insert the finger into the finger insertion portion 223 to easily lift the rear end portion of the pen body 110, thereby easily detaching the pen body 110 from the adapter body 210.

In addition, as illustrated in FIGS. 5 to 12, the pen body fitting portion 222 may further include a pen body fitting protrusion 222c. he pen body fitting protrusion 222c may be formed to protrude from the adapter body 210 so as to correspond to the through-hole 111 of the pen body 110. Accordingly, when the pen body 110 is fitted below the pen body support portion 222a and a rear area of the pen body 110 is pressed from above to below, the pen body fitting protrusion 222 c is fitted into the through-hole 111 of the pen body 110, thereby increasing a fastening force. Further, after fitting, the pen body 110 is prevented from being separated rearward of the adapter body 210, thereby further increasing assembly stability.

In particular, as illustrated in FIGS. 8 to 10, the pen body fitting protrusion 222c may have a length protruding further above an upper surface of the pen body 110 in a state where the pen body fitting protrusion 222 c is fitted into the through-hole 111. Accordingly, while a user lifts a rear end portion of the pen body 110 by inserting one finger (e.g., an index finger) into the finger insertion portion 223 in a state where the pen body fitting protrusion 222c is fitted into the through-hole 111, another finger (e.g., a thumb) may press an end of the pen body fitting protrusion 222c, and thus the pen body 110 may be easily detached from the adapter body 210.

Hereinafter, the wrist strap attachment portion 230 will be described in more detail with reference again to FIGS. 5 to 8.

As illustrated in FIGS. 5 to 8, the wrist strap attachment portion 230 may include a wrist contact portion 231, a spacer connection portion 232, and a wrist strap insertion/removal hole 233. The wrist contact portion 231 may be provided to be spaced apart from a surface of the adapter body 210 facing a user's wrist. The spacer connection portion 232 may connect the wrist contact portion 231 to one side of the adapter body 210 in a spaced-apart state. The wrist strap insertion/removal hole 233 may form a space between the adapter body 210 and the wrist contact portion 231, and may allow a wrist strap (not shown) to be inserted and removed. Accordingly, the adapter 200 of the present disclosure may be detachably attached to the wrist strap (i.e., mounted on or removed from the wrist strap) easily and quickly in a manner in which the wrist strap is inserted into and removed from the wrist strap insertion/removal hole 233.

Furthermore, as illustrated in FIGS. 7 and 8, the wrist strap attachment portion 230 may further include a wrist strap press portion 234. The wrist strap press portion 234 may apply a fixing force to the wrist strap in a state where the wrist strap (not shown) is inserted into the wrist strap insertion/removal hole 233. Accordingly, in a state where the adapter 200 is attached to the wrist strap, the adapter 200 may be firmly fixed to the wrist strap through the wrist strap press portion 234.

For example, as illustrated in FIGS. 7 and 8, the wrist strap press portion 234 may protrude convexly from the adapter body 210 toward the wrist contact portion 231 and may elastically press and fix the wrist strap (not shown) inserted into the wrist strap insertion/removal hole 233.

Although preferred embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A pen, comprising:
a pen body having a rectangular shape cross-section; and
a cartridge seating portion provided in the pen body, wherein a cartridge is detachably seated in the cartridge seating portion,
wherein the cartridge seating portion extends diagonally across the rectangular cross-section between two non-adjacent vertices of the pen body,
wherein the pen body includes through-holes respectively formed through left and right sides of the pen body with respect to the cartridge seating portion,
wherein the cartridge seating portion defines a tubular passage into which the cartridge is insertable,
wherein the pen further comprises a cartridge removal portion for removing the cartridge from the cartridge seating portion,
wherein the cartridge removal portion comprises a cartridge rear-end insertion hole that:
is formed through a rear end of the cartridge seating portion such that a rear end of a cartridge in use is partially exposed;
is formed to have a size into which a rear end of an external replacement cartridge is insertable; and
guides, when the rear end of the replacement cartridge is inserted, the cartridge in use to be withdrawn through a distal end of the cartridge seating portion, and
wherein a center of the cartridge rear-end insertion hole is offset to one side from a center of the cartridge seating portion.

2. An adapter for detachably attaching the pen of claim 1 to a wrist strap worn on a user's wrist, comprising:
an adapter body;
a pen attachment portion forming a portion of the adapter body and configured to detachably attach the pen; and
a wrist strap attachment portion forming another portion of the adapter body and configured to be detachably attached to the wrist strap.
